(19) United States
(12) Patent Application Publication
(10) Pub. No.: US 2015/0188941 A1
(43) Pub. Date: Jul. 2, 2015

(54) METHOD AND SYSTEM FOR PREDICTING VICTIM USERS AND DETECTING FAKE USER ACCOUNTS IN ONLINE SOCIAL NETWORKS

(71) Applicant: TELEFONICA DIGITAL ESPANA, S.L.U., Madrid (ES)

(72) Inventors: Yazan BOSHMAF, Madrid (ES); Dionysios LOGOTHETIS, Madrid (ES); Georgios SIGANOS, Madrid (ES)

(73) Assignee: TELEFONICA DIGITAL ESPANA, S.L.U., Madrid (ES)

(21) Appl. No.: 14/140,965

(22) Filed: Dec. 26, 2013

(51) Int. Cl. H04L 29/06

(52) U.S. Cl. CPC H04L 63/1441

(57) ABSTRACT

A system and method for predicting victims and detecting fake accounts in OSNs, comprising: a feature-based classifier for predicting victims by classifying, with a classification probability, a target variable of each user in the OSN social graph; a graph-transformer for transforming the social graph into a defense graph by reassigning edge weights to incorporate victim predictions using the classification probability, a graph-based detector for detecting fake users by computing through the power iteration method a probability of a random walk to land on each node in the defense graph after 0(log n) steps, assigning to each node a rank value equal to a node's landing probability normalized by the node degree, sorting the nodes by their rank value and estimating a detection threshold such that each node whose rank value is smaller than the detection threshold is flagged as representing a fake account.

### FIELD OF THE INVENTION

The present invention has its application within the telecommunication sector, and especially, relates to Online Social Networking (OSN) services, such as Facebook, Twitter, Digg, LinkedIn, Google+, Tuenti, etc., and their security mechanisms against attacks originating from automated fake user accounts (i.e., Sybil attacks).

### BACKGROUND OF THE INVENTION

Traditionally, the Sybil attack in computer security represents the situation wherein a reputation system is subverted by forging identities in peer-to-peer networks through creating a large number of pseudonymous identities and then using them to gain a disproportionately large influence. In an electronic network environment, particularly in Online Social Networks (OSNs), Sybil attacks are commonplace due to the open nature of these networks, where an attacker creates multiple fake, each called a Sybil node, and pretends to be multiple real users in the OSN.

Attackers can create fake accounts in OSNs, such as Facebook, Twitter, Google+, LinkedIn, etc., for various malicious activities. This includes but is not limited to: (1) sending unsolicited messages in bulk in order to market products such as prescription drugs (i.e., spamming), (2) distributing malware, which is a short term for malicious software (e.g., viruses, worms, backdoors), by promoting hyperlinks that point to compromised websites, which in turn infect users' personal computer when visited, (3) biasing the public opinion by spreading misinformation (e.g., political smear campaigns, propaganda), and (4) collecting private and personally identifiable user information that could be used to impersonate the user (e.g., email addresses, phone numbers, home addresses, birthdates).

In order to tackle the abovementioned problem, OSNs today employ fake account detection systems. In case that an OSN provider could detect Sybil nodes in its system effectively, the experience of its users and their perception of the service could be improved by blocking annoying spam messages and invitations. The OSN provider would be also able to increase the marketability of its user base and its social graph and to enable other online services or distributed systems to employ a user's online social network identity as an authentic digital identity.

Existing fake account detection systems can fall under one of two categories, described as follows:

A) Feature-Based Detection:

This detection technique relies on pieces of information called features that are extracted from user accounts (e.g., gender, age, location, membership time) and user activities on the website (e.g., number of photos posted, number of friends, number of “likes”). These features are then used to predict the class to which an account belongs (i.e., fake or legitimate), based on a prior knowledge called ground-truth.

The ground-truth is the correct class to which each user belongs in the OSN. Usually, the OSN has access to a ground-truth that is only a subset of all the users in the OSN (otherwise, no prediction is necessary).

The user class, also called its target variable, is the classification category to which the user belongs, which is one of the possible classification decisions (e.g., fake or legitimate accounts, malicious or benign activity) made by a classifier.

For example, if the number of posts the user makes is larger than a certain threshold, which is induced from known fake and legitimate accounts (e.g., 200 posts/day), then the corresponding user account is flagged as malicious (i.e., spam) fake account.

A classifier is a calibrated statistical model that, given a set of feature values describing a user (i.e., a feature vector), predicts the class to which the user belongs (i.e., the target variable). Classification features are numerical or categorical values (e.g., number of friends, gender, age) that are extracted from account information or user activities. Through a process known as feature engineering, these features are selected such that they are good discriminators of the target variable. For example, if the user has a very large number of friends, then the user is likely to be less selective with whom it connect with in the OSN, including fake accounts posing as real humans. Accordingly, one expects such users to be more likely to be victims of fake accounts.

The state-of-the-art in feature-based detection is a system called the Facebook Immune System (FIS) [“Facebook immune system” by Tao Stein et al., Proceedings of the 4^{th} Workshop on Social Network Systems, ACM, 2011], which was developed by Facebook and deployed on their OSN with the same name. The FIS performs real-time checks and classification on every user action on its website based on similar features extracted from user accounts and activities. This process is done in two stages:
1. Offline classifier training: In this stage, a k-dimensional feature vector is extracted for each user in the OSN that is known to be either fake or legitimate, along with a binary target variable describing the corresponding class of the user. Each feature in this vector describes a unique user account information or activity either numerically or categorically (e.g., age=24 years, gender=“male”). After that, all available feature vectors and their corresponding target variables are used to calibrate a statistical model using known statistical inference techniques, such as polynomial regression, support vectors machines, decision tree learning, etc.
2. Online user classification: In this stage, the calibrated statistical model, which is now referred to as a binary classifier, is used to predict the class to which a user belongs by predicting the value of the target variable with some probability, given its k-dimensional feature vector.

Feature-based detection technique is efficient but does not provide any provable security guarantees. As a result, an attacker can easily evade detection by carefully mimicking legitimate user activities up until the actual attack is launched. This circumvention technique is called adversarial classifier reverse engineering [“Adversarial learning” by Daniel Dowd et al., Proceedings of the 11^{th} ACM SIGKDD international conference on Knowledge discovery in data mining, ACM, 2005], where the attacker learns sufficient information about the deployed classifier (e.g., its detection threshold) to minimize the probability of being detected, sometimes down to zero. For example, an attacker can use many fake accounts for spamming by making sure each account sends posts just below the detection threshold, which can be induced by naïve techniques such as binary search. In binary search-based induction, the attacker, for example, starts by sending 400 posts/day/account, and if blocked the attacker cuts the number of posts in half. Otherwise, the attacker doubles the number of posts and then repeats the experiment. Eventually, the attacker selects the largest number of posts to send per day per account that does not result in any of the fake accounts being blocked.

As a result of this weakness, the FIS was able to detect only 20% of the automated fake accounts used in a recent infiltration campaign, where more than 100 fake accounts where used to connect with more than 3K legitimate users for the purpose of collecting their private information, which reached up to 250 GB in about 8 weeks. In fact, almost all the detected accounts were manually flagged by concerned users but not through the core detection algorithms.

B) Graph-Based Detection:

In this technique, an OSN is modelled as a graph called the social graph, where nodes represent users and edges between nodes represent social relationships (e.g., user profiles and friendships in Facebook). Mathematically, the social graph is a combinatorial object consisting of a set of nodes and a collection of edges between pairs of nodes. In OSNs, a node presents a user and an edge represents a social relationship between two users. An edge can be directional (e.g., followership graph in Twitter) or unidirectional (e.g., friendship graph in Facebook). An edge between a node representing a legitimate user account and another node representing a fake user account is called an attack edge. Also, an edge can have a numerical weight attached to it (e.g., quantifying trust, interaction intensity). In a social graph, the degree of a node is the number of edges connected/incident to the node. For weighted graphs, the node degree is the sum of the weights of the edges incident to the node.

The graph structure is analysed by, for example, inspecting the connectivity between users, calculating the average number of friends or mutual friends, etc., in order to compute a meaningful rank value for each node. This rank quantifies how trustworthy (i.e., legitimate) the corresponding user is, where a higher rank implies a more trustworthy or legitimate user account.

For example, by looking at the graph structure, one can identify isolated user accounts, which do not have friends, and flag them as suspicious or not trustworthy, as they are likely to be fake accounts. This can be achieved by assigning a rank value to each node that is equal to itsdegree (i.e., number of relationships the corresponding user has), normalized by the largest degree in the graph. This way, nodes with rank values close to zero are considered suspicious and represent isolated, fake accounts.

In the social graph of an OSN, there can be also multi-community structures. A community is a sub-graph that is well connected among its nodes but weakly (or sparsely) connected with other nodes in the graph. It represents cohesive, tightly knit group of people such as close friends, teams, authors, etc. There are several community detection algorithms to identify communities in a social graph, e.g., the Louvain method described by Blondel et al. in “Fast unfolding of communities in large networks”, Journal of Statistical Mechanics: Theory and Experiment 2008 (10), P10008 (12pp).

Graph-based detection technique is effective in theory and provides formal security guarantees. These guarantees, however, hold only if the underlying assumptions are true, which is often not the case, as follows:
1) Real-world social graphs consist of many small periphery communities that do not form one big community. This means that the social graph is not necessary fast-mixing.
2) Attackers can infiltrate OSNs on a large scale by tricking users into establishing relationships with their fake accounts. This means that it is not necessary that there is a sparse cut separating the sub-graph induced by the legitimate accounts and the rest of the graph.

As a result, graph-based detection generally suffers from bad ranking quality, and therefore, low detection performance, rendering it impractical for real-world deployments, including for example multi-community scenarios.

Another graph-based detection technique (here called SybilRank) is a system, deployed on the OSN called Tuenti, which detects fake accounts by ranking users such that fake accounts receive proportionally smaller rank values than legitimate user accounts, given the following assumptions hold:
The OSN knows at least one trusted account that is legitimate (i.e., not fake).
Attackers can establish only a small number of non-genuine or fake relationships between fake and legitimate user accounts.
The sub-graph induced by the set of legitimate accounts is well connected, meaning it represents a tightly knit community of users.

Given a small set of trusted, legitimate accounts, this graph-based detection technique used in Tuenti ranks its users as follows:
A random walk on the social graph is started from one of the trusted accounts picked at random. A random walk on a graph is a stochastic process where, starting from a given node, the walk picks one of its adjacent nodes at random and then steps into that node. This process is repeated until a stopping criterion is met (e.g., when a given number of steps is reached or a specific destination node is visited). The mixing time of the graph is the number of steps required for the walk to reach its stationary distribution, where he probability to land on a node does not change.
The random walk is set to perform 0(log n) steps, where n is number of nodes in the graph. The number of steps, which is called the walk length, is short enough such that it is highly unlikely to traverse one of the relatively few fake relationships in the graph, and accordingly, visit fake accounts. At the same time, the walk is long enough to visit most of the legitimate accounts, assuming that the sub-graph induced by the set of legitimate accounts is well-connected such that it is fast-mixing, which means it takes 0(log n) steps for a random walk on this sub-graph to converge to its stationary distribution, where the walk starts from a node in the sub-graph.
After the walk stops, each node is assigned a rank value that is equal to its landing probability, normalized by the node's degree (i.e., its degree-normalized landing probability).
Finally, the nodes are sorted by their rank values in 0(n·log n) time, where a higher rank value represent a more trustworthy or legitimate user account.

Overall, SybilRank takes 0(n·log n) time to rank and sort users in a given OSN, guarantying that at most 0(g·log n) fake accounts may have ranks equal or greater than the ranks assigned to legitimate users, where g is the number of fake relationships between fake and legitimate user accounts.

Consequently, it is desirable to efficiently and effectively integrate by design both (feature-based and graph-based) detection techniques in order to combine their strengths while reducing their weaknesses.

In this context, detection efficiency is defined as the time needed for a detection system to finish its computation and output the classification decision for each user in the OSN. For large systems, the efficiency is typically measured in minutes per input size (e.g., 20 minutes per 160 Million nodes).

In this context, detection effectiveness is defined as the capability of the detection system to correctly classify users in an OSN, which can be measured given the correct class of each user based on a ground-truth.

Therefore, given the expected financial losses and the security threats to the users, there is a need in the state of the art for a method that allows OSNs to detect fake OSN accounts as early as possible efficiently and effectively.

### SUMMARY OF THE INVENTION

The present invention solves the aforementioned problems by disclosing a method, system and computer program that detects Sybil (fake) accounts in a retroactive way based on a hybrid detection technique described here that sums up the strengths of feature-based and graph-based detection techniques and grants stronger security properties versus attackers. In addition, the present invention provides Online Social Network (OSN) operators with a proactive tool to predict potential victims of Sybil attacks.

In the context of the invention, a Sybil attack refers to malicious activity where an attacker creates and automates a set of fake accounts, each called a Sybil, in order to first infiltrate a target OSN by connecting with a large number of legitimate users. After that, the attacker mounts subsequent attacks such as spamming, malware distribution, private data collection, etc.

In the context of the invention, a victim is a user who accepted a connection request sent by a fake account (e.g., befriended a fake account posing as a human stranger). Being a victim is the first step towards opening other attack vectors such as spamming, malware distribution, private data collection, etc.

The present invention has its application to Sybil inference customized for OSNs whose social relationships are bidirectional.

In addition, the present invention can be applied along with abuse mitigation techniques, such as contextual warnings, computation puzzles (e.g., CAPTCHA), temporary user service suspension, account deletion, account verification (e.g., via SMS, email), etc., which can be used in the following scenarios: (1) whenever a potential victim is identified in order to prevent future attacks from potentially fake accounts, (2) whenever fake accounts are identified to remove the threat, and (3) whenever the user is given a very small rank as compared to other users, and before manual inspection of the ranked users.

In the present invention, the following assumptions are made:
i. The social graph is undirected and non-bipartite, which means random walks on the graph can be modeled as an irreducible and aperiodic Markov chain. This Markov chain is guaranteed to converge to a stationary distribution in which the landing probability on each node after a sufficient number of steps is proportional to the node's degree.
ii. The OSN has access to the entire social graph and all recent user activities.
iii. An attacker cannot established arbitrarily many attack edges in a relatively short period of time, which means that up to a certain point in time, there is a sparse cut between the Sybil and the non-Sybil regions. Sybil accounts have to first establish fake relationships with legitimate user accounts before they can execute their malicious activities. In other words, isolated fake accounts have little to no benefit for attackers as they can be easily detected and cannot openly interact with legitimate user accounts.

In the context of the invention, a random walk is a stochastic process in which one moves from one node to another in the graph by picking the next node at random from the set of nodes adjacent to the currently visited node. On finite, undirected, weighted graphs that are not bipartite, random walks always converge to the stationary distribution, where the probability to land on a node becomes relative to its degree.

In the context of the invention, a Markov chain is a discrete-time mathematical system that undergoes transitions from one state to another, among a finite or countable number of possible states. A Markov chain is said to be irreducible if its state space is a single communicating class; in other words, if it is possible to get to any state from any state. A Markov chain is said to be aperiodic if all states are aperiodic.

The present invention provides OSN operators with proactive victim prediction and retroactive fake account detection in two steps:
1) All potential victims in the OSN are identified with some probability using a number of “cheap” features extracted from the account information and user activities of legitimate accounts that have either accepted at least a single connection requests sent by a fake account (i.e., victims) or rejected all such requests. In particular, these features are used to calibrate a statistical model using statistical inference techniques in order to predict potential victims who are likely to connect with fake user accounts. Unlike existing feature-based detection, the present invention relies solely on features of legitimate user accounts that the attacker does not control, and therefore, it is extremely hard for the attacker to adversely manipulate or reverse engineer the calibrated classifier, as the classifier identifies victims of fake accounts not the fake accounts themselves.
2) Each user in the OSN is assigned a rank value that is equal to the landing probability of a short random walk, which starts from a trusted legitimate node, normalized by the nodes' degree. Unlike existing graph-based detection, the walk is artificially biased against potential victims by assigning relatively low weights to edged incident to them, where each edge weight is derived from the predictions provided by the calibrated classifier in the first step. An edge weight, in this case, represents how trustworthy the corresponding relationship is, where higher weights imply more trustworthy relationships. Accordingly, the random walk now choses the next node in its path with a probability proportional to edge weights. As a result, the walk is expected to spend most of its time visiting nodes representing legitimate accounts, as it is highly unlikely to traverse low-weight edges and subsequently visit fake accounts, even if the number of fake relationships (i.e., attack edges) is relatively large.

Thus, the present invention copes also with multi-community structures in OSNs by distributing the trusted nodes across global communities, which can be identified using community detection algorithms such as the Louvain method. Please, note that a community is usually fast mixing, the mixing time being defined as the number of steps needed for a random walk on the graph to converge to its stationary distribution. A graph is said to be fast-mixing if its mixing time is 0(log n) steps.

According to a first aspect of the present invention, a method of fake (Sybil) user accounts detection and prediction of victim (of Sybil users) accounts in OSNs is disclosed and comprises the following steps:
given an online social network (OSN), its social graph is obtained, the social graph being defined by a set of nodes which represent unclassified user accounts and a set of weighted edges which represent social relationships between users, where edge weights w indicate trustworthiness of the relationships, with an edge weight w=1 indicating highest trust and an edge weight w=0 indicating lowest trust;
predicting victims in the social graph by classifying, with a probability of classification P and using a feature-based classifier, a target variable of each user in the social graph;
Incorporating victim predictions into the social graph by reassigning edge weights to edges, depending on the following possible cases:
   i. edges incident only to non-victim nodes have reassigned edge weights w=1 indicating highest trust,
   ii. edges incident to one single victim node have reassigned edge weights w=1−P, which is multiplied by a configurable scaling parameter, indicating a lower trust than in case I,
   iii. edges incident only to multiple victim nodes have reassigned edge weights w=1−maximum prediction probability of victim pairs, which is multiplied by the same configurable scaling parameter as in case ii, indicating the lowest trust;
transforming the social graph into a defense graph by using the reassigned edge weights;
computing by the power iteration method a probability of a random walk to land on each node in the defense graph after 0(log n) steps, where the random walk starts from a node of the defense graph whose edges are in case i;
assigning to each node in the defense graph a rank value which is equal to a node's landing probability normalized by a degree of the node in the defense graph;
sorting the nodes in the defense graph by their rank value and estimating a detection threshold at which the rank value changes over a set of nodes,
detecting fake users by flagging each node whose rank value is smaller than the estimated detection threshold as a Sybil node.

In a second aspect of the present invention, a system, integrated in a communication network comprising a plurality of nodes, is provided for predicting victim users and for detecting fake accounts in an OSN modelled by a social graph, the system comprising:
a feature-based classifier configured for predicting victims in the social graph by classifying, with a probability of classification P, a target variable of each user in the social graph;
a graph-transformer for transforming the social graph into a defense graph by reassigning edge weights to edges to incorporate victim predictions into the social graph, reassigning edge weights based on the following cases of edges:
   i. edges incident only to non-victim nodes have reassigned edge weights w=1 indicating highest trust,
   ii. edges incident to one single victim node have reassigned edge weights w=1−P, which is multiplied by a configurable scaling parameter, indicating a lower trust than in case i,
   iii. edges incident only to multiple victim nodes have reassigned edge weights w=1−maximum prediction probability of victim pairs, which is multiplied by the same configurable scaling parameter as in case ii, indicating the lowest trust;
a graph-based detector for detecting fake users by:
computing by the power iteration method a probability of a random walk to land on each node in the defense graph after 0(log n) steps, where the random walk starts from a node of the defense graph whose edges are in case i;
assigning to each node in the defense graph a rank value which is equal to a node's landing probability normalized by a degree of the node in the defense graph;
sorting the nodes in the defense graph by their rank value and estimating a detection threshold at which the rank value changes over a set of nodes;
flagging each node whose rank value is smaller than the estimated detection threshold as a Sybil node.

In a third aspect of the present invention, a computer program is disclosed, comprising computer program code means adapted to perform the steps of the described method when said program is run on a computer, a digital signal processor, a field-programmable gate array, an application-specific integrated circuit, a micro-processor, a micro-controller, or any other form of programmable hardware.

The method and system in accordance with the above described aspects of the invention have a number of advantages with respect to prior art, summarized as follows:
The present invention enables proactive mitigation of attacks originating from fake accounts in OSNs by predicting potential victims who are likely to share relationships with fake accounts. This means OSNs can now help potential victims avoid falling prey to automated social engineering attacks, where the attacker tricks users into accepting his connection requests, by applying one of the known proactive user-specific abuse mitigation techniques, e.g., the aforementioned Facebook Immune System (FIS). For example, potential victims can reject connecting with possibly fake user accounts if they are better informed through privacy “nudges”, which represent warnings that communicate the implications of a security or privacy-related decision (e.g., by informing users that connecting with strangers means they can see their pictures). By displaying these warnings to only potential victims, the OSN avoids annoying all other users, which is an important property as user-facing tools tend to introduce undesired friction and usability inconvenience.
The present invention enables retroactive graph-based detection that is effective in the real world, which is achieved by incorporating victim predictions into the calculation of user ranks. This means that OSNs can now deploy effective graph-based detection that can withstand a larger number of fake relationships and accounts, and still deliver higher detection performance with desirable, provable security guarantees.
The present invention employs efficient methods to predict potential victims and detect fake accounts in OSNs, which in total take 0(n·log n+m) time, where n is the number of nodes and m is the number of edges in the social graph. This makes the present invention suitable for large OSNs consisting of hundreds of millions of users.

These and other advantages will be apparent in the light of the detailed description of the invention.

### BRIEF DESCRIPTION OF THE DRAWINGS

For the purpose of aiding the understanding of the characteristics of the invention, according to a preferred practical embodiment thereof and in order to complement this description, the following figures are attached as an integral part thereof, having an illustrative and non-limiting character:

FIG. 1 shows a schematic diagram of a social network topology modelled by a graph illustrating non-Sybil nodes, Sybil nodes, attack edges between them and users, including victims, associated with features and a user class.

FIG. 2 presents a data pipeline, divided into two stages, followed by a method for detecting Sybil nodes and predicting victims in an online social network, according to a preferred embodiment of the invention.

FIG. 3 shows a flow chart with the main steps of the method for detecting Sybil nodes in an online social network, in accordance with a possible embodiment of the invention.

FIG. 4 shows a block diagram of a trained Random Forest classifier used by the method for detecting Sybil nodes, according to a possible embodiment of the invention.

FIG. 5 shows a schematic diagram of an exemplary social graph, according to a possible application scenario of the invention.

### DETAILED DESCRIPTION OF THE INVENTION

The matters defined in this detailed description are provided to assist in a comprehensive understanding of the invention. Accordingly, those of ordinary skill in the art will recognize that variation changes and modifications of the embodiments described herein can be made without departing from the scope and spirit of the invention. Also, description of well-known functions and elements are omitted for clarity and conciseness.

The embodiments of the invention can be implemented in a variety of architectural platforms, operating and server systems, devices, systems, or applications. Any particular architectural layout or implementation presented herein is provided for purposes of illustration and comprehension only and is not intended to limit aspects of the invention.

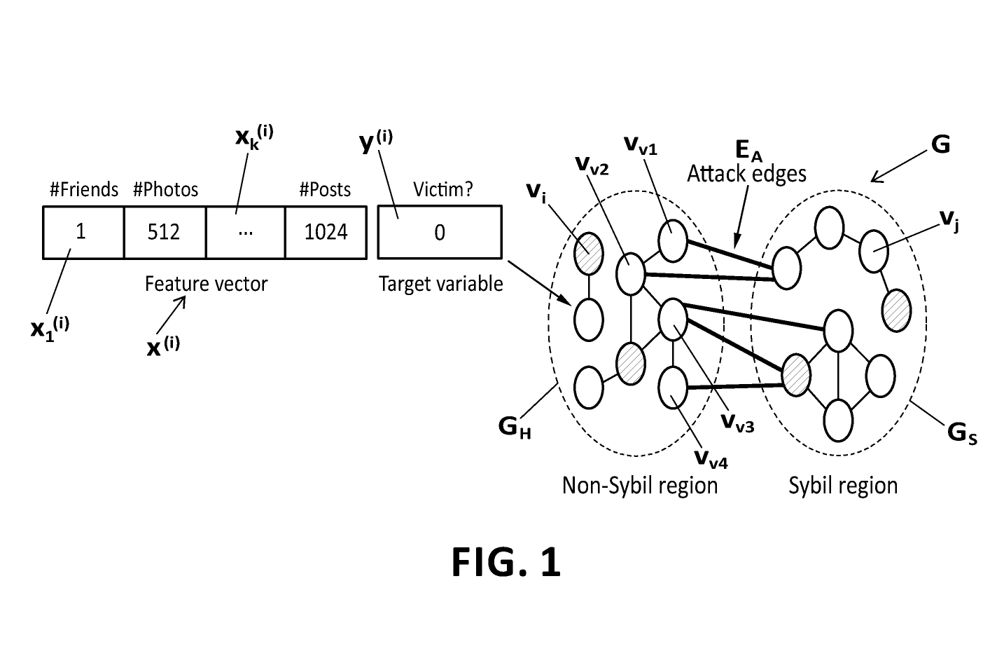

It is within this context, that various embodiments of the invention are now presented with reference to the FIGS. 1-5.

FIG. 1 presents a social graph G comprising a non-Sybil region G_{H} formed by the non-Sybil or honest nodes of an OSN and a Sybil region G_{S} formed by the Sybil or fake nodes of the OSN, both regions being separated but interconnected by attack edges E_{A}. Thus, an OSN is modelled as an undirected weighted graph G=(V,E, w), where G denotes the social network topology comprising vertices V that represent users accounts at nodes and edges E that represent trust social relationships between users. The weight function w: E→R⁺ assigns a weight w(vᵢ,v₁)>0 to each edge (vᵢ, Vⱼ)εE representing how trustworthy the relationship is, where a higher weight implies more trust. Initially, w(vᵢ,vⱼ)=1 for each (vᵢ,vⱼ)εE. In the social graph G, there are n=|V| nodes, m=|E| undirected edges, and a node Vᵢεεv has a degree of deg(vᵢ), which is defined by

$$deg ( {υ}_{i} ) := {\sum }_{( {υ}_{i} , {υ}_{j} ) ∈ E}^{ } w ( {υ}_{i} , {υ}_{j} ) \qquad ( equation 1 )$$

Bilateral social relationships are considered, where each node in V corresponds to a user in the network, and each edge in E corresponds to a bilateral social relationship. In this system model, users are referred to by their accounts and vice-versa, but the difference is marked when deemed necessary. Friendship relationship can be represented as an undirected edge E in the graph G and said edge E indicates that two nodes trust each other to not be part of a Sybil attack. Furthermore, the (fake) friendship relationship between an attacker or Sybil node and a non-Sybil or honest node is an attack edge E_{A}. For each user vᵢεv, a k-dimensional feature vector x⁽ⁱ⁾= [symbol] x₁⁽ⁱ⁾, . . . , xₖ⁽ⁱ⁾ [symbol] εR^{k} is defined, in addition to a user class or target variable y⁽ⁱ⁾ε{0,1}, where each feature xⱼ⁽ⁱ⁾εx⁽ⁱ⁾ describes a particular account information or user activity at a given point in time, and a unit target value y⁽ⁱ⁾=1 indicates the user is a victim of an attack originating from a fake account (i.e., the user has accepted at least a single connection request sent by a fake account). In FIG. 1, grey-colored nodes represent users who are known to be either Sybil or non-Sybil (i.e., ground-truth).

The present invention considers a threat model where attackers mount the Sybil attack, and a set of automated fake accounts, each called a Sybil, are created and used for many adversarial objectives. The node set v is divided into two disjoint sets, S and H, representing Sybil (i.e., fake) and non-Sybil (i.e., legitimate) user accounts, respectively. The Sybil region G_{S} is denoted by the sub-graph induced by S, which includes all Sybil users and their relationships. Similarly, the non-Sybil region G_{H} is the sub-graph induced by H. These two regions are connected by the set E_{A}⊂E of g distinct attack edges between Sybil and non-Sybil users. In FIG. 1, there are four victims (vᵥ₁, vᵥ₂, vᵥ₃, vᵥ₄), which are Non-Sybil nodes that share attack edges with Sybil nodes.

In a preferred embodiment of the invention, Random Forests (RF) learning and the power iteration method are used to efficiently predict victims and then compute the landing probability of random walks on large, weighted graphs. As defined in the state-of-the-art, RF is an ensemble learning algorithm used for classification (and regression) that operates by constructing a multitude of decision trees at training time and outputting the class that is the mode of the classes output by individual trees. A decision tree is a decision support tool that uses a tree-like graph or model of decisions and their possible consequences, including chance event outcomes, resource costs, and utility. It is one way to display an algorithm. The power iteration method is an algorithm used to approximate the eigenvalues of a matrix, more formally, given a matrix A, the algorithm producea a number λ (the eigenvalue) and a nonzero vector v (the eigenvector), such that Av=λv.

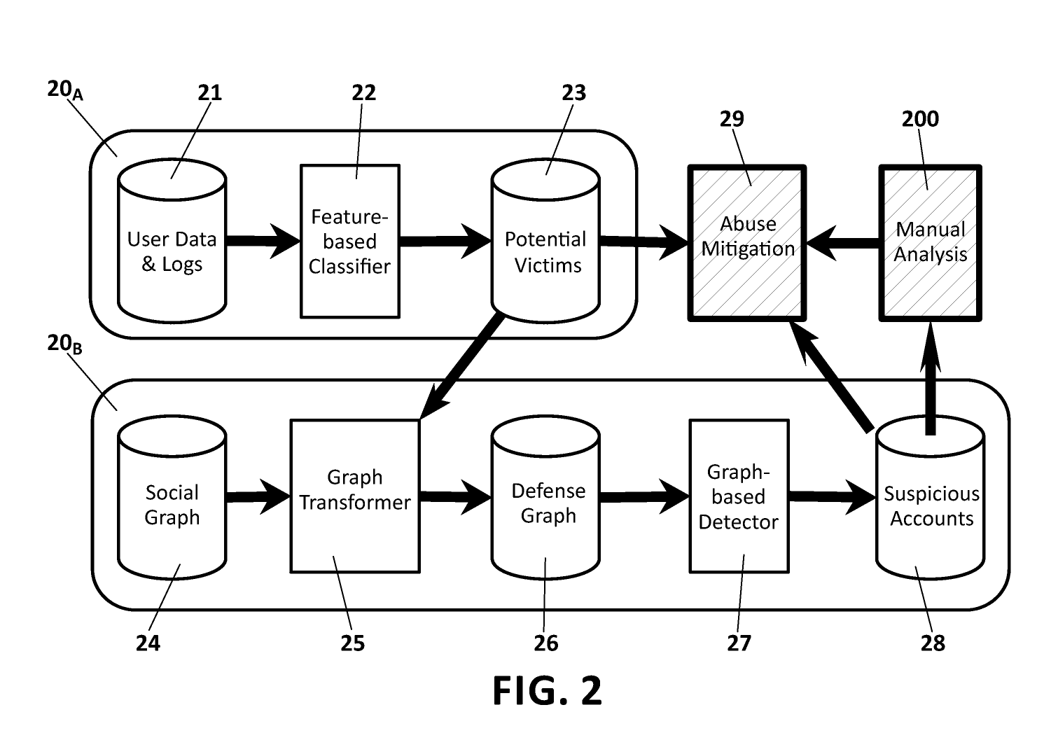

FIG. 2 presents a data pipeline 20 used in a preferred embodiment of the invention. Grey-colored blocks or components are external components crucial for proper system functionality. The data pipeline 20 is divided into two stages, 20_{A} and 20_{B}, where the system first predicts potential victims in steps 21, 22 and 23, and then identifies suspicious user accounts that are most likely to be Sybil through steps 24, 25, 26, 27 and 28, described in detail below.

The proposed method detects Sybil attacks and predicts potential victims by processing, through the data pipeline in two respectively stages, 20_{A} and 20_{B}, user activity logs 21 in a first stage 20_{A} and the system social graph 24 in a first stage 20_{B}. The method uses a Feature-based classifier 22, which is trained with the user data input and logs 21, in order to flag users as potential victims 23 using the target variable. This target variable of each user is input to a graph transformer 25, also fed by the social graph generated 24 to model the OSN. The graph transformer 25 generates a threat or defense graph 26 from the input social graph 24. This defense graph 6 is the one used in a Graph-based detector 27 to detect the Sybil, fake or suspicious accounts 28.

Having detected these fake accounts 28, abuse mitigation tools 29 and analitycal tools for manual analisys 200 performed by human experts can be applied. These additional steps 29, 200 at the end of the method for its complementation are beyond the scope of this invention, but their use is necessary in a real network scenario. OSN providers typically hire human experts who use analytical tools to decide whether the suspicious accounts flagged by the detection system are actually fake. Moreover, the experts usually re-estimate the detection threshold based on expert knowledge. The resulting classification is added to the ground-truth in order to keep the classifier up-to-date by retraining the classifier offline. In addition, many abuse mitigation techniques, e.g., contextual warnings, CAPTCHA, temporary user service suspension or definitively account deletion, account verification via SMS or email, etc., can be applied to the Sybil users which result from the detection system and the expert knowledge-based re-estimation by OSN's operators.

In order to flag users as potential victims 23, the proposed method and system identifies them in two further steps:
a. Offline classifier training: In this step, a classifier h is calibrated offline using a training dataset T={ [symbol] x⁽ⁱ⁾,y⁽ⁱ⁾ [symbol] :1≦i≦l} describing lε[1, n] users such that h(x) is an accurate predictor of the corresponding value of y.
b. Online potential victim classification: In this step, the calibrated classifier h is deployed online to identify potential victims by evaluating h(x⁽ⁱ⁾) for each user vᵢεV, and thus, predicting the value of y⁽ⁱ⁾ with a probability p⁽ⁱ⁾ε(0,1). As each training example [symbol] x⁽ⁱ⁾, y⁽ⁱ⁾ [symbol] εT can change over time, either by observing new user behaviors or by updating existing ground-truth, the two steps are regularly performed in order to avoid degrading the classification performance.

As mentioned before, the proposed method and system uses Random Forests—RF-learning to predict potential victims, as it is both efficient and robust against model over-fitting. RF is a bagging learning algorithm in which k₀≦k features are picked at random to independently construct ω decision trees, {h₁, . . . , h_{ω}}, using bootstrapped samples of the training dataset T. Given an example x⁽ⁱ⁾, the output of each decision tree hⱼ(x⁽ⁱ⁾) is then combined by a single meta-predictor h, as follows:

$$h ( {x}^{( i )} ) = {⊕}_{1 \leq j \leq ω} ( {h}_{j} ( {x}^{( i )} ) ) , \qquad ( equation 2 )$$

where the operator ⊕ is an aggregation function that performs majority-voting on the predicted value of the target variable y⁽ⁱ⁾ by each decision tree hⱼ, and computes the corresponding average probability p⁽ⁱ⁾.

Random Forests (RF) learning is a bagging or bootstrapped aggregating machine learning, that is, an ensemble meta-algorithm designed to improve the stability and accuracy of machine learning algorithms used in statistical classification and regression. It also reduces variance and helps to avoid Model over-fitting, which is a situation that occurs when a calibrated statistical model describes random error or noise instead of the underlying relationship.

In RF learning, training a classifier takes 0(ω·k₀·l log l) time and evaluating a single example takes 0(ω·k₀) time. Therefore, for a social graph G where ω, k₀ [symbol] n, it takes 0(n log n) time to train an RF classifier and 0(n) time to classify each node in the graph using this classifier; a total of 0(n log n).

At this first stage 20_{A}, the OSN has the leverage of proactively mitigating Sybil attacks by helping identified potential victims make secure decisions concerning their online befriending behavior. Another advantage of this approach is that attackers cannot adversely manipulate the classification by, for example, classifier reverse engineering (Social or classifier reverse engineering referts to a psychological manipulation of OSN users into performing unsecure actions, e.g., tricking the user into befriending a fake accounts by posing as a real, interesting person, or divulging confidential information, e.g., accessing private user account information by befriending users), as it is highly unlikely that an attacker is able to cause a change in user behavior, which is also regularly learned through h over time.

After identifying potential victims 23, at the next (second) stage 20_{B}, the proposed method and system identifies Sybil users by firstly transforming 5 the social graph G=(V, E, w) initially generated 4 into a defense graph D=(V, E, w) in step 26 by assigning a new weight w(vᵢ,vⱼ)ε(0,1] to each edge {vᵢ,vⱼ}εE in 0(m) time, as defined by:

$$w ( {υ}_{i} , {υ}_{j} ) = \{ \begin{matrix}α \cdot ( 1 - max \{ {p}^{( i )} , {p}^{( j )} \} ) & if {y}^{( i )} = 1 , {y}^{( j )} = 1 , \\ α \cdot ( 1 - {p}^{( i )} ) & if {y}^{( i )} = 1 , {y}^{( j )} = 0 , \\ α \cdot ( 1 - {p}^{( j )} ) & if {y}^{( i )} = 0 , {y}^{( j )} = 1 , \\ 1 & otherwise ,\end{matrix} \qquad ( equation 3 )$$

where αεR⁺ is a scaling parameter with a default value of α=2,
and y⁽ⁱ⁾ is the target variable or the class to which the user vᵢ is classified, this classification being predicted with probability p⁽ⁱ⁾ (the same notation applies to user vⱼ, with target variable yⁱⁱ⁾ and classification probability p^{(j)}.

The rationale behind this graph weighting scheme is as follows: potential victims are generally less trustworthy than other users, so assigning smaller weights to their edges strictly limits the aggregate weight over attack edges denoted by vol(E_{A})Σ (0,g], where the volume vol(F) of an edge set F⊂ is defined by:

$$vol ( F ) := {\sum }_{( {υ}_{i} , {υ}_{j} ) ∈ F}^{ } w ( {υ}_{i} , {υ}_{j} ) .$$

Now, given the defense graph D=(V, E, w), the probability of a random walk to land on vᵢ after 0(log n) steps is computed for each node vᵢεV, where the walk starts from a known non-Sybil node. After that, a node is assigned a rank equal to the node's landing probability normalized by its degree. The nodes are then sorted by their ranks in 0(n log n) time. Finally, a threshold φε[0,1] is estimated to identify nodes as either Sybil or not based on their ranks in the sorted list. Accordingly, the ranking and sorting process takes 0(n log n) time, which means that the overall method for detecting fake accounts takes 0(n log n+m) time. The ranking is done in such a way that legitimate user accounts ends up with approximately similar ranks, and the fake accounts with significantly smaller ranks closer to zero. In other words, if one sorts the users by their ranks, the rank distribution is an “S” shaped function where the threshold value is the point at which the curve steps up or down. This can be easily estimated by finding a range in node positions at which the rank values change significantly.

Let the probability of a random walk to land on a node be the node's trust value. As mentioned before, the proposed method uses a graph-based detector 27 applying the power iteration method to efficiently compute the trust values of nodes. This involves successive matrix multiplications where each element of the matrix is the transition probability of the random walk from one node to another. At each iteration, the trust distribution is computed over all nodes as the random walk proceeds by one step. Let πᵢ(vⱼ) denote the trust value of node vⱼεV after i iterations. Initially, the total trust in D, denoted by τ>0, is evenly distributed among n₀>0 trusted nodes in the honest region D_{H}, as follows:

$${π}_{0} ( {υ}_{j} ) = \{ \begin{matrix}τ / {n}_{0} & if {υ}_{j} is a trusted node , \\ 0 & otherwise\end{matrix} . \qquad ( equation 4 )$$

During each power iteration, a node first distributes its trust to its neighbors proportionally to their edge weights and degree. Then, the node collects the trust from its neighbors and updates its own trust, as follows:

$${π}_{i} ( {υ}_{j} ) = {\sum }_{( {υ}_{k} , {υ}_{j} ) ∈ E}^{ } {π}_{i - 1} ( {υ}_{k} ) \cdot \frac{w ( {υ}_{k} , {υ}_{j} )}{deg ( {υ}_{k} )} , \qquad ( equation 5 )$$

where the total trust is conserved throughout this process.

After R=β(log n) iterations, the method assigns a rank π̅_{β}(vⱼ) to each node vⱼεV by normalizing the node's trust by its degree, i.e.,

$${\overline{π}}_{β} ( {υ}_{j} ) := \frac{{π}_{β} ( {υ}_{j} )}{deg ( {υ}_{j} )} \geq 0. \qquad ( equation 6 )$$

The normalization is needed in order to lower the false positives from low-degree non-Sybil nodes and the false negatives from high-degree Sybils. This can be explained by the fact that if the honest region D_{H} is well connected, then after β iterations the trust distribution in D_{H} approximates the stationary distribution of random walks in the region. In other words, let D_{H} be fast-mixing such that random walks on D_{H} reach the stationary distribution in 0(log |H|) steps, then after β [symbol] log |H| power iterations on the whole graph D, the non-normalized trust value of each node vⱼεH is approximated by:

$${π}_{β} ( {υ}_{j} ) = c \cdot τ \cdot \frac{deg ( {υ}_{j} )}{{\sum }_{{υ}_{k} ∈ H}^{ } deg ( {υ}_{k} )} \qquad ( equation 7 )$$

where c>1 is a positive multiplier. Therefore, the normalization makes sure that the nodes in the honest region have nearly identical, which simplifies the detection process.

Finally, SybilPredict sorts the nodes in D by their rank values, resulting in a total order on n nodes:

[symbol]

v₁, π̅_{β}(v₁) [symbol] [symbol] . . . [symbol] [symbol] vₙ,π_{β}(vₙ) [symbol] . (equation 8)

Given a threshold φε[0,1], the method finally identifies a node vⱼεV as Sybil if its rank π̅(vⱼ)<φ generating a list of identified Sybil user accounts 28. Intuitively, it is expected that φ [symbol] π(vⱼ) for each VⱼεH, as the total trust is mostly concentrated in D_{H} and rarely propagates to D_{S}.

The proposed method offers desirable security properties since its security analysis assumes that the non-Sybil region is fast-mixing, although this method does not depend on the absolute mixing-time of the graph. In particular, its security guarantees are:

Given a social graph with a fast mixing non-Sybil region and an attacker that randomly establishes a set E_{A} of g attack edges, the number of Sybil nodes that rank same or higher than non-Sybil nodes after 0(log n) iteration is 0(vol(E_{A})·log n), where vol(E_{A})≦g.
For the case when the classifier h is uniformly random, the number of Sybil nodes that rank same or higher than non-Sybil nodes after 0(log n) iterations is 0(g·log n), given the edge weight scaling parameter is set to α=2
As each edge (vi, vj)εE is assigned a unit weight w(vi, vi)=1 so that vol(EA)=g, this means that the adversary can evade detection by establishing g=0(n/log n) attack edges. However, even if g grows arbitrarily large, the bound is still dependent on the classifier h from which edge weights are derived. This gives the OSN a unique advantage as h is calibrated using features extracted from non-Sybil user accounts that the adversary does not control.

If the detection system ranks users in order to classify them, which is based on a cutoff threshold in the rank value domain, which is the present case, then Receiver Operating Characteristic (ROC) analysis is typically used to quantify the performance of the ranking. ROC Analysis uses a graphical plot to illustrate the performance of a binary classifier as its detection threshold is varied. The ROC curve is created by plotting the True Positive Rate (TPR), which is the fraction of true positives out of the total actual positives, versus the False Positive Rate (FPR), which is the fraction of false positives out of the total actual negatives, at various threshold settings. TPR is also known as sensitivity (also called recall in some fields), and FPR is one minus the specificity or the True Negative Rate (TNR). The performance of a binary classifier can be quantified in a single value by calculating the Area Under its ROC Curve (AUC). A randomly uniform classifier has an AUC of 0.5 and a perfect classifier has an AUC of 1. In the present invention, the detection effectiveness of the method results in approximately 20% FPR and the system provides 80% TPR with an overall AUC of 0.8.

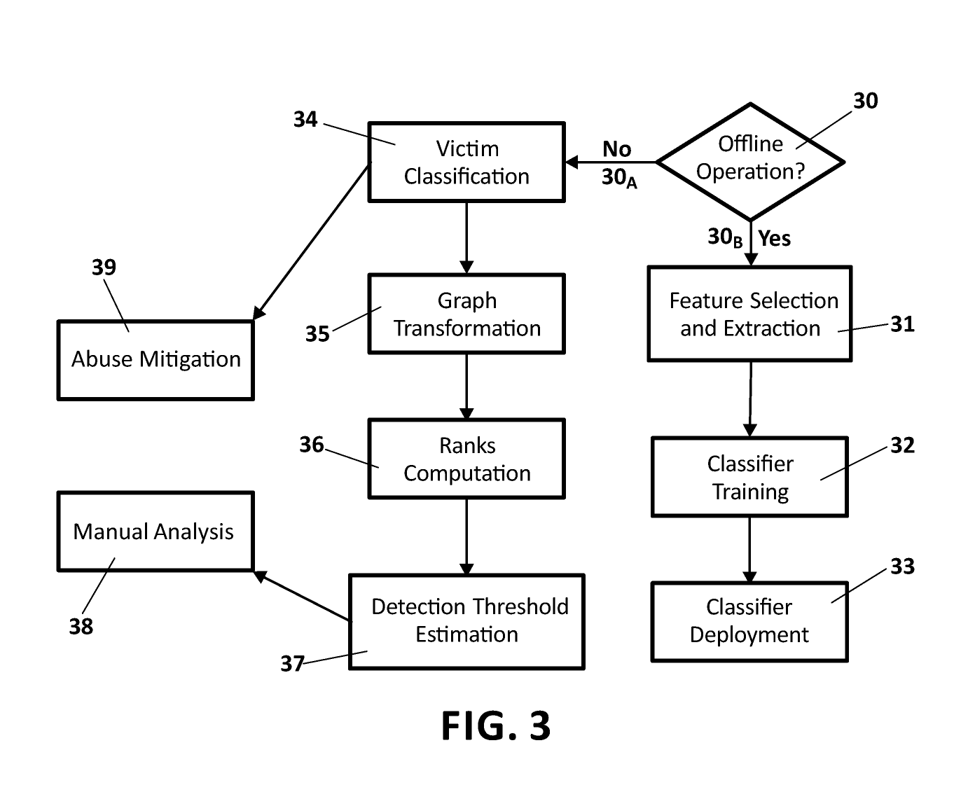

The present invention can be implemented in various ways using different software architectures and infrastructures. The actual embodiment thereof depends on the resources available to the implementer. Without loss of generality, the following FIGS. 3-5 discloses an exemplary embodiment that serves as a representative illustration of the invention, following the flow chart presented in FIG. 3 and described as follows.

The first steps of the proposed method depend on whether it is operating with a classifier 30 in online mode 30_{A} or offline operation 30_{B}.

Consider the prior knowledge shown below in Table 1, which describes users in an OSN like Facebook where each user received at least one “friend request” from fake accounts. Accordingly, there are two classes of users: (a) victims who accepted at least one request, and (b) non-victims who rejected all such requests.

In Offline operation 30_{B}, the first step is to select and extract features from users' account information 31. In the example of Table 1, two features are extracted from account information, e.g., Facebook profile page, in order to calibrate an RF classifier. The rationale behind this feature selection is that one expects young users who are not selective with whom they befriend to be more likely to befriend fake accounts posing as real users (i.e., strangers).

TABLE 1
Exemplary training dataset

| | |
|---|---|
| Feature vectors (k = 2) | Target variable |

| Friends (count) | Age (years) | Victims? |
|---|---|---|
| 7 | 18 | 1 |
| 7 | 19 | 1 |
| 8 | 20 | 1 |
| 9 | 20 | 1 |
| 1 | 20 | 0 |
| 5 | 26 | 0 |
| 5 | 21 | 1 |
| 7 | 21 | 0 |

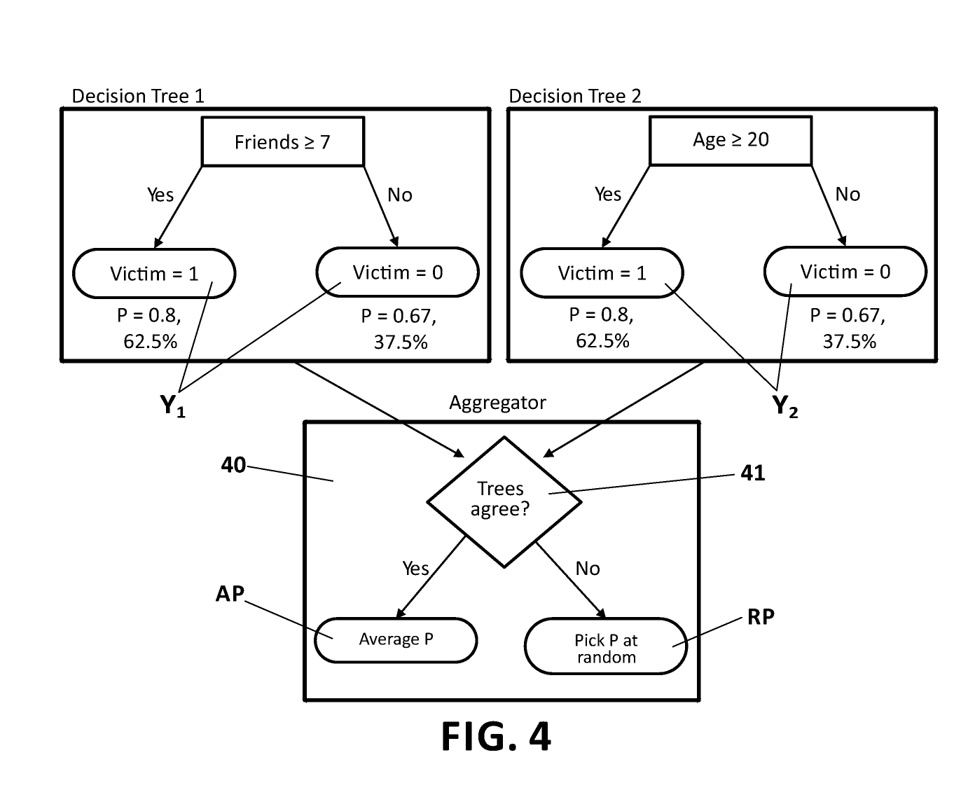

Using this prior knowledge of Table 1 as a training dataset for offline classifier training 32, the proposed method calibrates a binary classifier using the RF learning algorithm. In this example, ω=2 Decision Trees (DTs) and k₀=1 random features are selected for offline training. The resulting binary RF classifier deployed 33 using training data is shown in FIG. 4.

The aggregator 40 in FIG. 4 performs a majority voting between the two DTs, a first decision tree DT₁ and a second decision tree DT₂, and in case the trees agree 41 on the target variables, Y₁, Y₂, the aggregator 40 outputs the average of the corresponding probabilities AR Otherwise, the aggregator 40 picks one of the DTs at random, and then outputs its predicted target variable along with its probability, denoted here by RP random probability. The annotation under the leaves of each DT represent the probability P of the predicted class (i.e., victim or not), followed by the percentage of the training dataset size from which the probability was computed.

For example, in the first decision tree DT₁, there are a total of 5 feature vectors (62.5% of the 8 feature vectors in the training dataset) that have the first feature value ≧7. For these 5 vectors, the probability P of a user to be a victim is 4/5=0.8 (given the user has ≧7 friends).

Finally, the calibrated RF classifier is deployed online, meaning that it will be used to predict whether users are victims 34 on possibly new feature vectors that have not been seen in offline training.

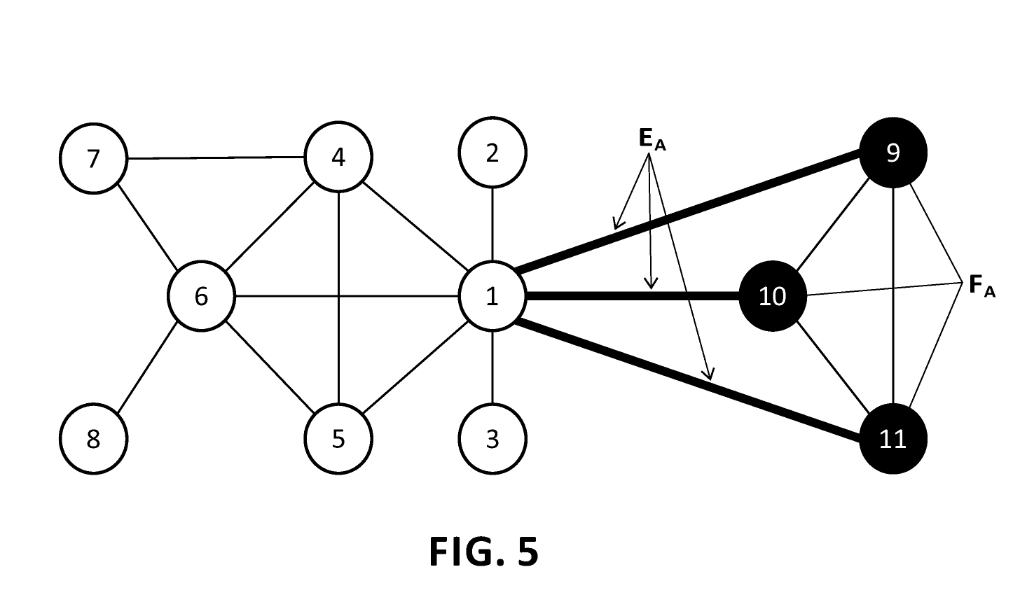

For Online victim classification 34, consider as an example the social graph shown in FIG. 5 to be used for graph transformation 35. FIG. 5 shows Thick lines representing attack edges E_{A}, Black nodes represent fake accounts F_{A} and the numbers within the (black and white, Sybil and non-Sybil) nodes refers to users' account identity (User ID). The goal is to maximize the number of correctly identified fake accounts (i.e., the True Positive Rate, or TPR), while minimizing the number of legitimate accounts incorrectly identified as fake (i.e., the False Positive Rate, or FPR).

For each node in the graph, the proposed method first extracts a feature vector, describing the same features used in offline training, and use the deployed RF classifier to predict the target value which classifies 34 the users as victims (target value=1) or not, as shown in Table 2.

TABLE 2
Feature vectors for the users of the social graph (shown in FIG. 4).

| | Feature vectors (k = 2) | | Predicted target variable | |
|---|---|---|---|---|
| User ID | Friends (count) | Age (years) | Victims? | Probability |
| 1 | 8 | 18 | 1 | 0.8 |
| 2 | 1 | 19 | 0 | 1 |
| 3 | 1 | 25 | 0 | 1 |
| 4 | 4 | 29 | 0 | 1 |
| 5 | 3 | 21 | 0 | 1 |
| 6 | 5 | 27 | 0 | 1 |
| 7 | 2 | 22 | 0 | 1 |
| 8 | 1 | 19 | 1 | 0.8 |
| 9 | 3 | 23 | 0 | 1 |
| 10 | 3 | 24 | 0 | 1 |
| 11 | 3 | 23 | 0 | 1 |

For example, for the user with ID=2, DT1 and DT2 disagree on the predicted target value, and in this case, the aggregator breaks the tie by picking one tree at random, which is DT1 in this case. As the prediction is not a victim, the corresponding edge weight is set to 1.

The, the method proceeds to perform the graph transformation 35: Having the prediction ready, the social graph is transformed into a defense graph, which is achieved through assigning a new weight for each edge in the graph, as shown in Table 3, being the scaling parameter used in the weight definition of equation 3, α=1.

TABLE 3
Weights for each relationship in the social graph (shown in FIG. 4)

| (i, j) | y⁽ⁱ⁾ | y^{(j)} | p⁽ⁱ⁾ | P^{(j)} | w(i, j) |
|---|---|---|---|---|---|
| (7, 6) | 0 | 0 | 1 | 1 | 1 |
| (8, 6) | 1 | 0 | 0.8 | 1 | 0.2 |
| (6, 4) | 0 | 0 | 1 | 1 | 1 |
| (6, 5) | 0 | 0 | 1 | 1 | 1 |
| (6, 1) | 0 | 1 | 1 | 0.8 | 0.2 |
| (2, 1) | 0 | 1 | 1 | 0.8 | 0.2 |
| (1, 3) | 1 | 0 | 0.8 | 1 | 0.2 |
| (1, 9) | 1 | 0 | 0.8 | 1 | 0.2 |
| (1, 10) | 1 | 0 | 0.8 | 1 | 0.2 |
| (1, 11) | 1 | 0 | 0.8 | 1 | 0.2 |
| (10, 9) | 0 | 0 | 1 | 1 | 1 |
| (10, 11) | 0 | 0 | 1 | 1 | 1 |
| (9, 11) | 0 | 0 | 1 | 1 | 1 |

For example, for the edge (8,6) in FIG. 4, as the user with ID=8 is predicted to be a victim while the other is not, the corresponding weight is 1·(1−0.8)=0.2.

The next steps are ranking 36 of the users and estimation of the detection threshold 37. For this example, a total trust τ=100 is used and the user with ID=6 is picked as a trusted, legitimate node. Having the social graph transformed, SybilPredict ranks the nodes in the graph through β=┌log 11┐=2 power iterations, as shown in Table 4.

TABLE 4
Rank computations for the social graph users (shown in FIG. 4).

| i | πᵢ(1) | πᵢ(2) | πᵢ(3) | πᵢ(4) | πᵢ(5) | πᵢ(6) | πᵢ(7) | πᵢ(8) | πᵢ(9) | πᵢ(10) | πᵢ(11) | πᵢ(S) |
|---|---|---|---|---|---|---|---|---|---|---|---|---|
| 0 | 0 | 0 | 0 | 0 | 0 | 100 | 0 | 0 | 0 | 0 | 0 | 0 |
| 1 | 5.882 | 0 | 0 | 29.412 | 29.412 | 0 | 29.412 | 5.882 | 0 | 0 | 0 | 0 |
| 2 | 4.404 | 0.735 | 0.735 | 28.81 | 28.81 | 43.883 | 9.191 | 0 | 0.735 | 0.735 | 0.735 | 2.206 |

In the present invention, the first significant increment in the rank values when the nodes are sorted in a descending order occurs at φ=4.404 (going from 0 to 0.735 and the to 4.404), where three legitimate accounts are misclassified but all of the fakes are identified, as shown in Table 5, where nodes with black background are identified as fake, and the rest of the nodes are identified as legitimate accounts.

TABLE 5
Nodes of the social graph (shown in FIG. 4) are sorted by rank values.

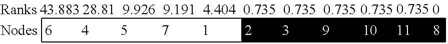

Therefore, there is a clear definition of regions to estimate a detection threshold 37.

To summarize, in the example illustrated above, the present invention achieves a better ranking than the prior art solutions due to two factors:
the aggregate landing probability in the Sybil region is significantly smaller,
the identified potential victim with ID=1 is ranked lower, which is desirable as this user is less trustworthy than other non-victims.

The results can be re-estimated by manual analysis 38 and the final results can be used by existing abuse mitigation tools 39, whose description is out of the scope of the invention.

Comparing the present embodiment of the invention (here called SybilPredict) with the graph-based detection technique deployed on Tuenti, aforementioned in prior-art as SybilRank, which detects fake accounts by ranking users such that fake accounts receive proportionally smaller rank values than legitimate user accounts, Table 6 shows the results obtained for this prior-art solution. The input data used in analysing SybilRank is the same than the inputs used before in SybilPredict, except that all edges have a unit weight, 3.4 times more trust to escape the non-Sybil region into the Sybil region (meaning the random walk has significantly higher probability to land on nodes in the Sybil region which consists of fake accounts). Table 7 shows the nodes of FIG. 4 ranked by SybilRank, where nodes with black background are identified as fake, and the rest of the nodes are identified as legitimate accounts.

TABLE 6
Rank computations for the social graph users (shown
in FIG. 4) obtained using SybilRank prior-art system.

| i | πᵢ(1) | πᵢ(2) | πᵢ(3) | πᵢ(4) | πᵢ(5) | πᵢ(6) | πᵢ(7) | πᵢ(8) | πᵢ(9) | πᵢ(10) | πᵢ(11) | πᵢ(S) |
|---|---|---|---|---|---|---|---|---|---|---|---|---|
| 0 | 0 | 0 | 0 | 0 | 0 | 100 | 0 | 0 | 0 | 0 | 0 | 0 |
| 1 | 20 | 0 | 0 | 20 | 20 | 0 | 20 | 20 | 0 | 0 | 0 | 0 |
| 2 | 11.666 | 2.5 | 2.5 | 19.166 | 7.5 | 44.166 | 5 | 0 | 2.5 | 2.5 | 2.5 | 7.5 |

TABLE 7
Nodes of the social graph (shown in FIG. 4) are sorted by rank values in
SybilRank prior-art system.

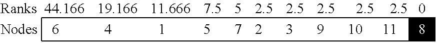

Comparing Tables 4-5 with Tables 6-7 and summarizing the examples, SybilPredict achieves a first significant increment in the rank values when the nodes are sorted in a descending order occurs at φ=4.404 (going from 0 to 0/35 and the to 4.404), where three legitimate accounts are misclassified but all of the fakes are identified. In SybilRank, however, the first significant increase is at φ=0.25 (going from 0 to 0.25), where one legitimate account is misclassified and no fake accounts are identified. Moreover, the second increase in the rank values has the same increment of 0.25. Therefore, with SybilRank, there is no clear intuition about how to estimate detection threshold in this example.

Note that in this text, the term “comprises” and its derivations (such as “comprising”, etc.) should not be understood in an excluding sense, that is, these terms should not be interpreted as excluding the possibility that what is described and defined may include further elements, steps, etc.

1. A method for predicting victim users and detecting fake users in online social networks, comprising:
obtaining a social graph of an online social network which is defined by a set of nodes representing unclassified user accounts and a set of weighted edges representing social relationships between users, where edge weights w indicate trustworthiness of the relationships, with an edge weight w=1 indicating highest trust and an edge weight w=0 indicating lowest trust;
predicting victims in the social graph by classifying, with a probability of classification P and using a feature-based classifier, a target variable of each user in the social graph;
incorporating victim predictions into the social graph by reassigning edge weights to edges, depending on the following cases of edges:
i. edges incident only to non-victim nodes have reassigned edge weights w=1 indicating highest trust,
ii. edges incident to one single victim node have reassigned edge weights w=1−P, which is multiplied by a configurable scaling parameter, indicating a lower trust than in case i,
iii. edges incident only to multiple victim nodes have reassigned edge weights w=1−maximum prediction probability of victim pairs, which is multiplied by the same configurable scaling parameter as in case ii, indicating the lowest trust;
transforming the social graph into a defense graph by using the reassigned edge weights;
computing by the power iteration method a probability of a random walk to land on each node in the defense graph after 0(log n) steps, where the random walk starts from a node of the defense graph whose edges are in case i;
assigning to each node in the defense graph a rank value which is equal to a node's landing probability normalized by a degree of the node in the defense graph;
sorting the nodes in the defense graph by their rank value and estimating a detection threshold at which the rank value changes over a set of nodes; and
detecting fake users by flagging each node whose rank value is smaller than the estimated detection threshold as a Sybil node.

2. The method according to claim 1, wherein predicting victims comprises:
offline training of the feature-based classifier with a first feature vector describing features selected from a user′ dataset to obtain,
deploying online the trained feature-based classifier to predicting the target variable using a second feature vector different from the a first feature vector and describing the selected features used for offline training.

3. The method according to claim 1, wherein the feature-based classifier is Random Forests.

4. The method according to claim 1, wherein detecting fake users comprises using manual analysis by the online social network based on the nodes identified as Sybil.

5. The method according to claim 1, further comprising applying abuse mitigation to the detected fake users.

6. The method according to claim 1, wherein transforming the social graph into a defense graph D comprises reassigning a weight w(vᵢ, vⱼ)>0 to each edge (vᵢ,vⱼ)εE, where the weight for each (vᵢ, vⱼ)εE is defined by:
$$w ( {υ}_{i} , {υ}_{j} ) = \{ \begin{matrix}α \cdot ( 1 - max \{ {p}^{( i )} , {p}^{( j )} \} ) & if {y}^{( i )} = 1 , {y}^{( j )} = 1 , \\ α \cdot ( 1 - {p}^{( i )} ) & if {y}^{( i )} = 1 , {y}^{( j )} = 0 , \\ α \cdot ( 1 - {p}^{( j )} ) & if {y}^{( i )} = 0 , {y}^{( j )} = 1 , \\ 1 & otherwise ,\end{matrix}$$
where αεR⁺ is the configurable scaling parameter, y⁽ⁱ⁾ is the target variable of a first node vᵢεV with a probability p⁽ⁱ⁾ to be classified by the feature-based classifier as victim and y^{(j)} is the target variable of a second node vⱼεV with a probability p^{(j)} to be classified by the feature-based classifier as victim.

7. A system for predicting victim users and detecting fake accounts in an online social network modelled by a social graph which is defined by a set of nodes which represent unclassified user accounts and a set of weighted edges which represent social relationships between users, where edge weights w indicate trustworthiness of the relationships, with an edge weight w=1 indicating highest trust and an edge weight w=0 indicating lowest trust;
wherein the system comprises:
a feature-based classifier configured for predicting victims in the social graph by classifying, with a probability of classification P, a target variable of each user in the social graph;
a graph-transformer for transforming the social graph into a defense graph by reassigning edge weights to edges to incorporate victim predictions into the social graph, reassigning edge weights based on the following cases of edges:
i. edges incident only to non-victim nodes have reassigned edge weights w=1 indicating highest trust,
ii. edges incident to one single victim node have reassigned edge weights w=1−P, which is multiplied by a configurable scaling parameter, indicating a lower trust than in case i,
iii. edges incident only to multiple victim nodes have reassigned edge weights w=1−maximum prediction probability of victim pairs, which is multiplied by the same configurable scaling parameter as in case ii, indicating the lowest trust; and
a graph-based detector for detecting fake users by:
computing by the power iteration method a probability of a random walk to land on each node in the defense graph after 0(log n) steps, where the random walk starts from a node of the defense graph whose edges are in case i;
assigning to each node in the defense graph a rank value which is equal to a node's landing probability normalized by a degree of the node in the defense graph;
sorting the nodes in the defense graph by their rank value and estimating a detection threshold at which the rank value changes over a set of nodes; and
flagging each node whose rank value is smaller than the estimated detection threshold as a Sybil node.

8. A computer program comprising computer program code means adapted to perform the steps of the method according to claim 1, when said program is run on a computer, a digital signal processor, a field-programmable gate array, an application-specific integrated circuit, a micro-processor, a micro-controller, or any other form of programmable hardware.
